(19) United States
(12) Patent Application Publication
(10) Pub. No.: US 2016/0158112 A1
(43) Pub. Date: Jun. 9, 2016

(54) PLUSH ANIMAL SHAPED TOY WITH PACIFIER

(71) Applicant: Aki Summers, Byron, GA (US)

(72) Inventor: Aki Summers, Byron, GA (US)

(21) Appl. No.: 14/957,189

(22) Filed: Dec. 2, 2015

Related U.S. Application Data
(60) Provisional application No. 62/086,835, filed on Dec. 3, 2014.

(51) Int. Cl. A61J 17/00; A63H 3/00; A63H 3/28; A63H 3/02

(52) U.S. Cl. CPC A61J 17/007; A63H 3/02; A63H 3/003; A63H 3/28

(57) ABSTRACT

A plush animal shaped toy for intellectually stimulating, entertaining, and calming an infant-toddler, comprising at least: one rattle mechanism; one squeeze mechanism; a sound box to emit a recorded voice and/or melody; and a detachable pacifier with cover attached via Velcro-like material near the animal's mouth. The toy may further comprise visual symbols printed, stitched, or patched on the exterior animal surface, such as letters of the alphabet or numeric numbers. Exemplary embodiments comprise: a caterpillar; an elephant; a lamb; a monkey; and a puppy; and the sound box emits the ABC song when the designated animal's paw, hoof, or mid-section is pressed. The rattle mechanism is housed within the animal's head, and the squeeze and press mechanism and sound box are housed within the animal's body. A “Press” patch is sewn onto a hoof or paw bottom, or midsection and connected to the sound box via a wire.

### PRIORITY CLAIM

This application claims priority to U.S. Provisional Patent Application Ser. No. 62/086,835 filed on Dec. 3, 2014 and incorporated herein in its entirety by this reference thereto.

### FIELD OF THE DISCLOSURE

In general the present disclosure relates to an apparatus for a toy with a detachable pacifier, and its method of making and using. In particular, the present disclosure relates to a plush toy in the shape of an animal with a detachable pacifier that displays letters of the alphabet on the toy surface, emits a rattling noise when shaken, a squeaky noise when squeezed at a designated area, and a song when pressed on a designated area.

The trademarks, website names, programming language names, etc. that are used in the present disclosure are the property of the respective owner companies and are used herein for illustrative purposes only.

### BACKGROUND OF THE DISCLOSURE

Infants and toddlers need constant attention to keep them calm and happy, and to provide intellectual stimulation to properly develop the neural networks in their brains, especially within their first three years. Unfortunately, caregivers are not always available to provide them direct contact, thus toys and pacifiers are often used to substitute for human contact. To this end, stuffed animals with attached pacifiers are widely available, such as Paci-Plushies®. Unfortunately, some companies market a variety of stuffed animals with pacifiers permanently attached to the nose (e.g. WabbaNub®), which prevents the caregiver from being able to easily replace and/or clean the pacifier.

Additionally, US Patent Application 20100304636 to Seiz, published Dec. 2, 2010, discloses a stuffed frog with a pacifier attached to the paw using a releasable tab. And U.S. Pat. No. 6,666,740 to Schneider, that issued Dec. 23, 2003, discloses a stuffed puppy with a pacifier attached to the muzzle. Likewise, US Design Patent D609284 to Markland, that issued Feb. 2, 2010, discloses a stuffed teddy bear with a pacifier extending vertically upward from the top of the head. What all of these toys lack, though, is additional auditory and visual stimulation to educate and entertain the infants-toddlers.

Scientific research over the last two or more decades has repeatedly linked the importance of music (e.g. lullabies, the ABC song, etc.) to soothing a child and to their future learning abilities. For example, Curtin and Zamuner demonstrated that when infants listen to soothing melodic lullabies, they can be moved into a hypnotic state that increases their oxygen saturation and reduces their stress (“Understanding the developing sound system: interactions between sounds and words”, Wiley Interdiscip Rev CognSci, September 2014, 5: 589-602).

Other research by Duff et al demonstrated that an infant's vocabulary is a statistically significant predictor of their later development in vocabulary, phonological awareness, reading accuracy, and reading comprehension (“Do infant vocabulary skills predict school-age language and literacy outcomes?”, J Child Psychol Psychiatry, August 2015, 56(8): 848-56). And research has shown that: “Circuits in the auditory cortex, representing the sounds that form words, are wired by the age of 1. The more words a child hears by 2, the larger her vocabulary will grow.” (“Your Child's Brain”, Begley, Sharon, Newsweek, 1996).

Therefore, there is a need for a plush toy with a detachable pacifier that comforts and intellectually stimulates an infant-toddler using visual and auditory cues, ultimately stimulating sensory development which is often recommended and preferred by pediatricians alike.

### SUMMARY OF THE DISCLOSURE

The various embodiments of the present disclosure comprise multiple features in one animal shaped plush toy to soothe, entertain, and intellectually stimulate an infant-toddler. The various embodiments of the animal shaped plush toy disclosed herein comprises one or more features of: a detachable pacifier with cover; a rattle mechanism; a squeeze mechanism; an auditory emitting mechanism for playing pre-recorded spoken words and/or songs; and/or visual cues comprising letters of the alphabet, numbers, and/or symbols displayed on the toy's surface.

As used herein, the term “animal” refers to any living creature (e.g. mammal, insect, bird, etc.) that may be configured into a plush toy small and light weight enough to be easily handled by an infant-toddler. Exemplary embodiments of the plush toy animals disclosed herein comprise: a caterpillar; an elephant; a lamb; a monkey and a puppy; from which one of skill in the art would readily be able to produce living creatures of other species based on this disclosure.

Plush: each of the animals disclosed herein is stuffed and covered with soft material that is able to be spot cleaned and/or laundered in the washing machine. The material may further comprise various colors for descriptive purposes (e.g. to create the illusion of a face), and/or for aesthetic appearances to amuse the infant (e.g. each segment of the caterpillar is a different bright color). And the outer material may further comprise additional decorations, such as letters of the alphabet, numeric figures or other symbols to educate and/or amuse the infant-toddler.

Pacifier: a detachable pacifier with a nipple cover extends from the animal's surface. In one or more exemplary embodiments, a pacifier extends from or near the animal's mouth with the handle attached temporarily to or near the mouth surface, while the opposing nipple end is pointed away from the animal for easy access by the infant-toddler. The nipple end may further comprise a cover to protect the nipple from contamination when not in use. And the pacifier may be attached using a releasable mechanism, such as by using a tab of industrial grade Velcro-type fastening element and/or material sewn near or onto the animal's mouth in both primary, secondary, or a combination of both colors.

Rattle: The toy further comprises an internal mechanism to emit a rattling noise when the animal is shaken. In an embodiment, a small solid object (e.g. bead, bean, ball, etc.) is encased within a hollow container, such as small pill box, circular or oval shaped device, etc. that is housed within the animal. When the animal is shaken, the solid object contacts the inner sides of the container and emits a “rattling” noise. The location of the rattle within the animal can vary depending on design choices, e.g. the head, stomach, tail section, etc.

Squeeze: The toy further comprises an internal mechanism to emit a squeaky sound when the animal is squeezed. In an embodiment (e.g. in the caterpillar), the squeeze mechanism is housed on the right and/or left side, or stomach-underside of the animal, although other locations within the animal that are easily accessible by an infant's hands (e.g. center of mass) are within the scope of this disclosure. The location may further comprise a “Squeeze” designation imprinted or stitched on the animal's outer surface-material, or the like (e.g. a patch sewn on that says “Squeeze”). The squeeze mechanism comprises a compressible, hollow, air-filled, plastic device with a small opening that when compressed from the external surface of the animal, air is forced out of the device opening and a “squeaky” noise is emitted.

Auditory: The toy further comprises an internal mechanism to emit sounds (e.g. melodies, lullabies, talking/singing voice, etc.) when the animal is pressed at a designated location (e.g. bottom of paw). In an embodiment, the internal mechanism comprises a “sound box” within the body of the animal that is activated by compression (e.g. in the caterpillar embodiment) and/or by stimulation and/or other switching mechanism well known in the art, such as a box that is connected to an animal's bottom paw or other area on the body via a connector (e.g. a wire). The activation location may further comprise a “Press” or “Press Me” designation imprinted or stitched or a patch sewn on the animal's outer surface/material, or the like. A variety of songs suitable for infants-toddlers are envisioned within the scope of this disclosure, such as the “ABC” song tune, a nursery rhyme, a lullaby, or the like. The sound box may also emit spoken words in addition to, or in lieu of, music.

Visual Cues: The external surface of the animal may further comprise words, letters of the alphabet, numerical numbers, and/or symbols printed or stitched or a patch sewn onto the animal at a location that is easily viewable. These visual cues are designed to stimulate the infant-toddler's neurons to entertain and train their brains. For example, they may begin to correlate letters of the alphabet displayed on a caterpillar body with the “ABC song” that plays when the “Press” patch is pressed on.

With respect to the above description, before explaining at least one preferred embodiment of the herein disclosed disclosure in detail, it is to be understood that the disclosure is not limited in its application to the details of construction and to the arrangement of the components in the following description or illustrated in the drawings. The disclosure herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present disclosure.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

Objects, features, and advantages of the disclosure will be brought out further in the following part of the specification, wherein detailed description is for the purpose of fully disclosing the disclosure without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. In the drawings:

FIG. 1A is a front elevational view of a caterpillar toy with a pacifier extending from the caterpillar's mouth;

FIG. 1B is a top plan view of the caterpillar toy;

FIG. 1C is a right side view of the caterpillar toy;

FIG. 1D is a bottom plan view of the caterpillar toy;

FIG. 1E is a left side view of the caterpillar toy;

FIG. 2A is a front elevation view of an elephant toy without a pacifier attached;

FIG. 2B is a rear elevation view of the elephant toy;

FIG. 2C is a right side view of the elephant toy;

FIG. 2D is a top plan view of the elephant toy with a pacifier attached;

FIG. 2E is a bottom plan view of the elephant toy with a pacifier attached;

FIG. 3A is a front elevational view of a lamb toy with a pacifier attached;

FIG. 3B is a right side view of the lamb toy with a pacifier;

FIG. 3C is a bottom plan view of the lamb toy without a pacifier showing a Velcro strip;

FIG. 3D is a top plan view of the lamb toy without a pacifier;

FIG. 4A is a front elevational view of a monkey toy with a pacifier;

FIG. 4B is a bottom plan view of the monkey toy with a pacifier;

FIG. 4C is a top plan view of the monkey toy with a pacifier;

FIG. 4D is a right side view of the monkey top with a pacifier;

FIG. 5A is a front elevation view of a puppy toy with a pacifier;

FIG. 5B is a top plan view of the puppy toy with a pacifier;

FIG. 5C is a bottom plan view of the puppy toy with a pacifier; and

FIG. 5D is a right side view of the puppy toy with a pacifier.

### DETAILED DESCRIPTION OF EXEMPLARY EMBODIMENTS OF THE DISCLOSURE

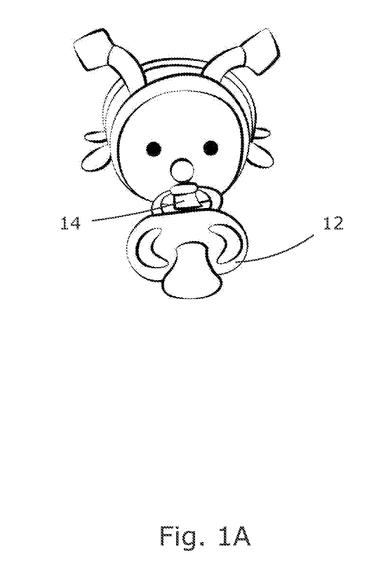

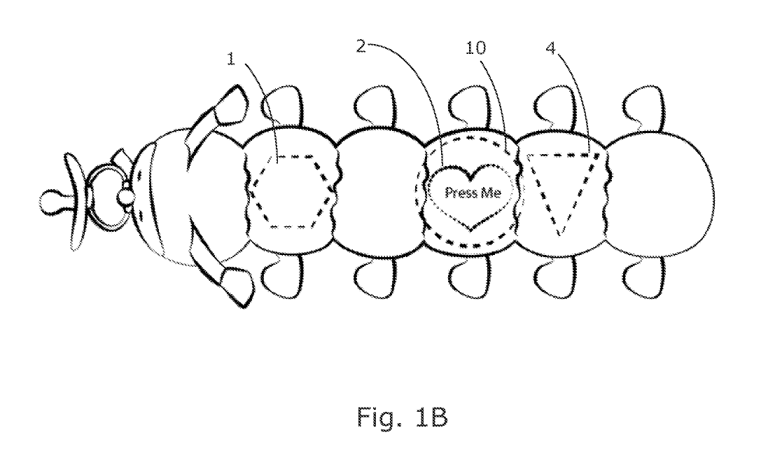

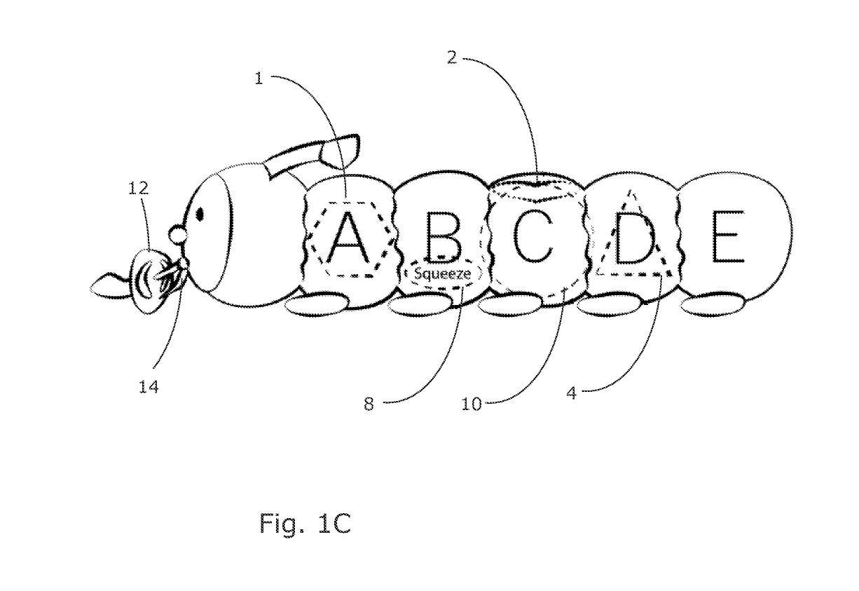

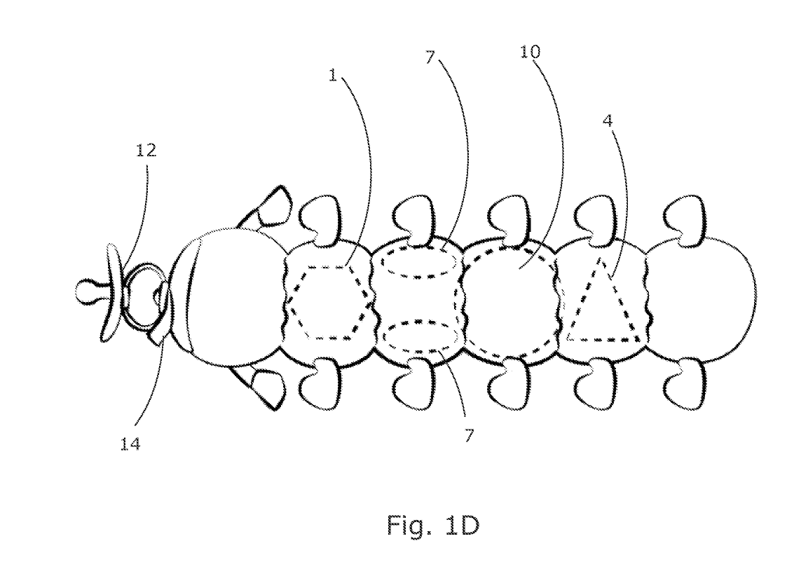

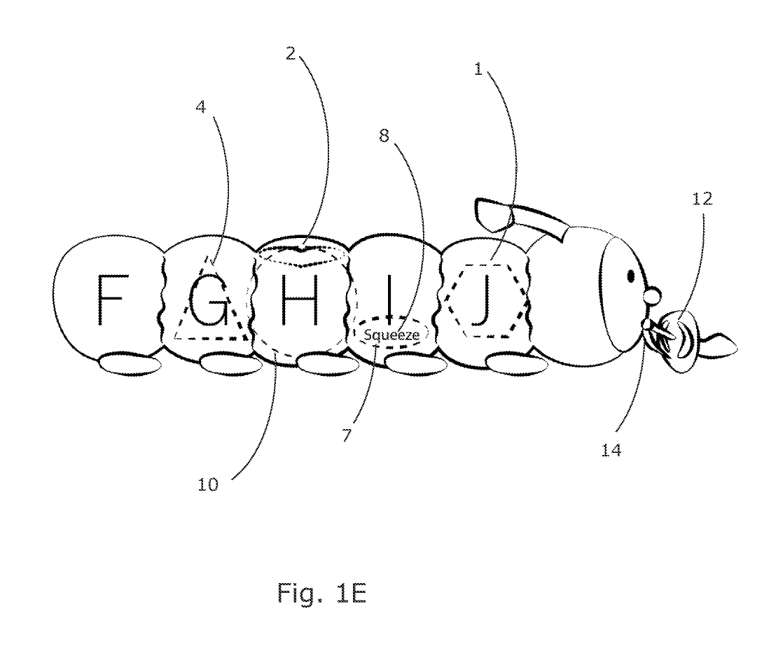

Now referring to drawings of exemplary embodiments in FIGS. 1-5D, wherein similar components are identified by like reference numerals, there is seen in the figures the following components, wherein internal components are denoted by dotted lines indicating their location, but not their actual shape.

The internal rattle mechanism 1 is shaped as a dotted hexagon for illustrative purposes only. Its actual shape is determined by the shape of the container that the rattle is housed within. The small hollow container may comprise a variety of shapes, such as: a pill box (i.e. flat top and bottom with a circular side wall); an oval or circular shape, etc. Housed within the container is a small, hard object (or a ball, bean, etc.) stored within. Whichever direction the animal is shaken will cause the hard ball to impact the interior surface of the container and emit a rattling noise. In the exemplified embodiments herein, the rattle mechanism 1 is within the head segment of the animal.

In the exemplary embodiments in the figures, the externally displayed “Press” or “Press Me” designation section 2 is located on the right and/or left side, top and/or underbelly of the animal. It is noted, though, that section 2 can be located anywhere on the external part of the animal; and, it may comprise a patch, stitching, or imprint imbedded in the animal's plush coat in a variety of shapes. The designated press section 2 is optional, but in the exemplified embodiments there is one section 2 comprising a heart shaped patch labelled “Press” or “Press Me” sewn into the bottom of the paw or hoof of an animal (e.g. lamb, elephant, monkey, puppy), or on the right and left side, or top and bottom of a caterpillar.

The designated press section is connected to at least one sound box 4 that is shaped as a dotted triangle for illustrative purposes only. In the exemplary embodiments in the figures, the sound box 4 comprises three miniature batteries and a music or vocal chip in direct contact with the batteries to ultimately prolong the batteries' life. The music or vocal chip is preprogrammed before placement. The box 4 is turned on and off via a switch well known in the art, such as a compressive, reed, magnetic, electric switch, or the like.

In the embodiments of legged animals (e.g. elephant, monkey, puppy, lamb, etc.), the sound box 4 is connected to the “Press” or “Press Me” designation section 2 via an internal connector wire 6 that activates a switch on or within the box 4 when section 2 is pressed. But in legless animals (e.g. a caterpillar), the designation section 2 activates the sound box 4 by pressing on a compressible member 10 internal to the animal (e.g. see dotted circle 10 in FIGS. 1A-1E) that bends and distorts to exert a compressive force on the sound box 4 that is directly beneath the section 2, or on a neighboring segment. When member 10 contacts sound box 4 with sufficient force, then the pre-recording plays. When pressed again with sufficient force, then the pre-recording stops.

Each animal may also comprise at least one or two “Squeeze” designation sections 8 located at a variety of locations within the animal. These sections comprise a patch, stitching or imprinting on the animal's fake fur coat that is located any external animal surface, such as the right and/or left side, top or underbelly. In the exemplified embodiments, when the animal is legged, then one “Squeeze” designation section 8 is located on the animal's underbelly. When the animal is legless (e.g. the caterpillar), then two directly opposing section 8 patches are located on opposite sides of the animal and the infant squeezes both concurrently.

Furthermore, a squeeze internal mechanism 7 is positioned directly beneath the “Squeeze” designation section 8 and within the body of the animal. For the purpose of illustration only, the internal squeeze mechanism 7 is shaped as a dotted circle or oval in the figures, which does not limit the actual shape of mechanism 7. It is also noted, that an internal squeeze mechanism 7 need not have a designation section (patch) 8 covering it. The animal may be so small and compressible, that squeezing it at most areas on the body will activate the squeeze mechanism 7 to emit a squeaky noise.

The various embodiments of the animals disclosed herein further comprise an optional a pacifier attachment device, and a pacifier 12, with or without a nipple cover, that in the exemplary embodiments is temporarily attached near the animal's mouth using an industrial grade Velcro® attaching mechanism 14 that may be white, or in any other color, to secure the pacifier handle to the animal's surface. In the exemplified embodiments, a rectangular piece of material comprising Velcro-like sections is permanently fixed to hang from one end near the animal's mouth. The opposing, hanging end of the material is manually threaded through the closed loop on the pacifier handle, and temporarily attached to the fixed end of the material using the Velcro-like section so as to secure the pacifier 12 to the animal. The Velcro-like section comprises industrial grade adhesions so that the material may be repeatedly attached and detached, but only by using force of a magnitude that an adult, or non-infant, non-toddler can generate. Therefore, an infant-toddler can hold the toy by merely sucking on the pacifier nipple, while an adult can easily remove and exchange the pacifier 12 at will (e.g. to clean it).

### Caterpillar Toy

FIGS. 1A-1E illustrate an exemplification of the caterpillar toy comprising six semi-circular segments from front to rear with the features (e.g. rattle, squeeze, sound box, visual external cues, etc.) incorporated into one or more segments. It is noted, though, that one of skill in the art could readily incorporate one or more of these features into another segment, and/or the caterpillar may comprise more or less than six segments while maintaining all of the features, and/or more or less features.

The first segment comprises a caterpillar head with a detachable pacifier and cover 12 that is attached below the mouth via a Velcro attaching element 14. It is preferred that the Velcro-like strip is industrial grade to withstand repeated pulling on the pacifier. Additionally, the first head segment may further comprise a pair of antennas extending upward; and each of segments two through six may further comprise a pair of feet extending downward from the bottom surface.

The second segment also comprises an internal rattle mechanism 1. Various versions of this type of mechanism are widely known in the toy industry such that one of skill in the art may easily substitute another rattle mechanism for the one disclosed herein. In the exemplary embodiment of the caterpillar (and other animals disclosed herein), a small solid object is encased within a hollow semi-solid, or solid pill box, circular, or oval (or the like) shaped container that is housed within the animal. It is noted that in the figures of the present disclosure, a hexagon shape is used to denote the location of the rattle mechanism, but not its actual shape, for one exemplary embodiment, and that other locations within the animal are easily within the ability of the artisan. When the animal is shaken, the solid object contacts the inner sides of the device and emits a “rattling” noise.

The third segment comprises a “Squeeze” designation (patch, machine stitching, embroidery, etc.) 8 placed on the bottom-underside of the caterpillar, or one or both sides, that when squeezed will make direct contact with the squeeze internal mechanism 4 to emit a squeaky noise. It is noted that the designation 8 may be located anywhere on this segment (or other segment) to effectively trigger the squeaky noise. In all embodiments, the squeeze mechanism comprises a compressible device that when compressed from the external surface of the animal, air is forced out of the device and a “squeaky” noise is emitted.

The fourth segment comprises a “Press” or “Press Me” designation 2 located on the top surface, although it may also be located additionally or alternatively on the bottom-underside or right and/or left side of segment four. This segment further comprises a mechanism 10 (denoted by a dotted circle) that will trigger the sound box 4 (in dotted triangular lines in the fifth segment) when patch 2 is pressed. In the caterpillar embodiment, unit 10 functions in lieu of the connector wire 6 used to connect patch 2 and sound box 4 in the embodiments of legged animals possessing paws or hoofs.

The last, sixth segment is the caterpillar backend which in the exemplified embodiment comprises no internal mechanisms. One of skill in the art could readily modify the sixth segment to house additional or alternative features, such as sound boxes, rattle, and/or squeeze mechanisms.

It is also noted that the caterpillar may be multi-colored in a manner to amuse and distract the infant, such as: a white face with a pink head and strip-colored antennas; a bright green second segment; a pink third segment; a white fourth segment; a purple fifth segment and a blue sixth segment. The individual segments may also be in other colors that visually attract and distract the infant and toddler.

The caterpillar may further comprise visual cues, such as alphabetic letters, numbers, and/or other symbols stitched or printed on the surface. In the exemplified embodiment, one letter each is stitched on segments two through six respectfully, on both the right and left side. By way of example, the second segment has letters A and J on the right and left side, respectfully; the third segment B and I; the fourth segment C and H; the fifth segment D and G; and the sixth segment E and F. In this embodiment, the toy can be used to intellectually stimulate and educate the infant, especially when used in conjunction with a sound box emitting the ABC Song.

### Elephant Toy

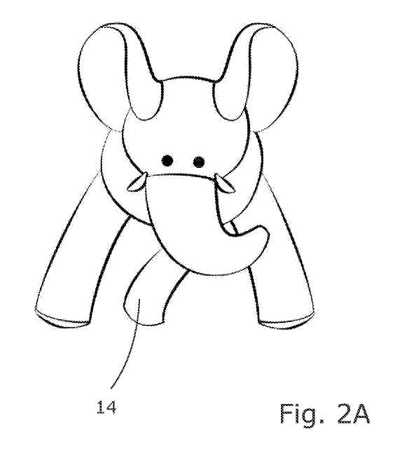

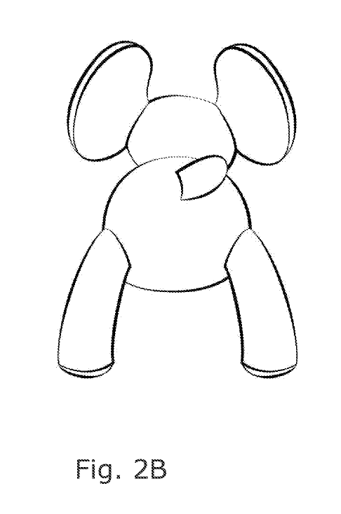

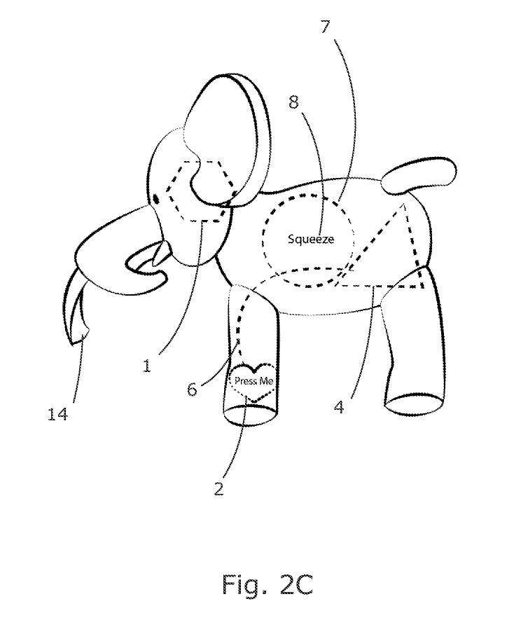

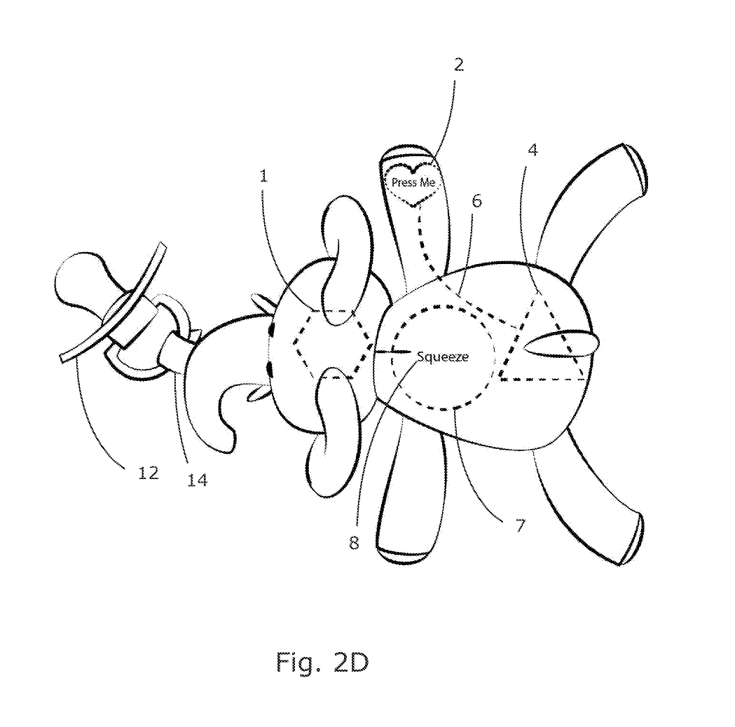

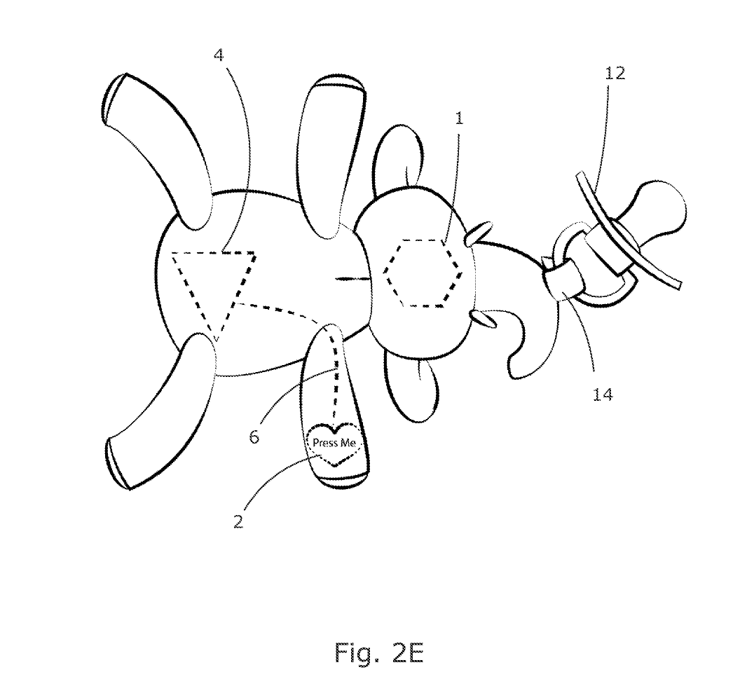

FIGS. 2A-2E illustrate an exemplified embodiment of the elephant. The rattle mechanism 1 is located with the elephant's head segment, although other locations within the animal are within the ability of the artisan. An internal squeeze mechanism 7 is located in the top to mid-section of the body unit-segment, and may further comprise a “Squeeze” designation 8 patch, imprint, or stitching on the surface of the elephant (top, or right and/or left side, or stomach-underside).

Furthermore, the right or left hoof may comprise a patch, stitching or imprint of the “Press Me” designation 2 on the underside of the hoof. Imprint 2 is connected via a connector wire 6 running internally up the hoof and leg to a sound box 4 located internally and near the rear of the body unit (i.e. near the tail).

And as illustrated in FIG. 2E, there is an industrial grade Velcro-like strip that can be folded over to temporarily attach the pacifier handle to the underside of the elephant's trunk. The pacifier may easily be removed using an adult force generated by pulling on the Velcro-like strip, but an infant-toddler is not strong enough to detach the Velcro strip.

### Lamb Toy

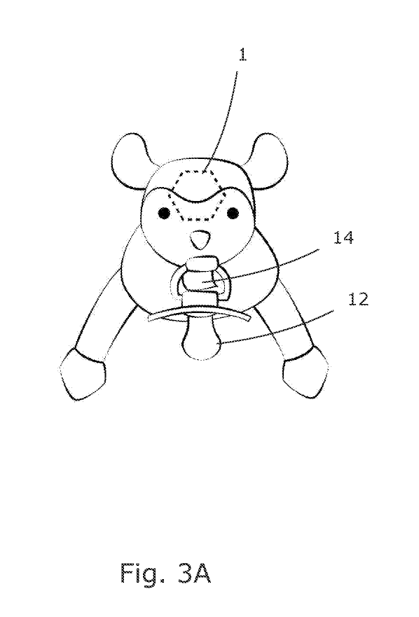

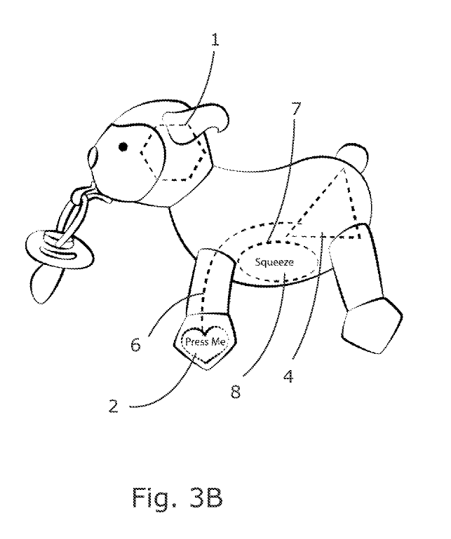

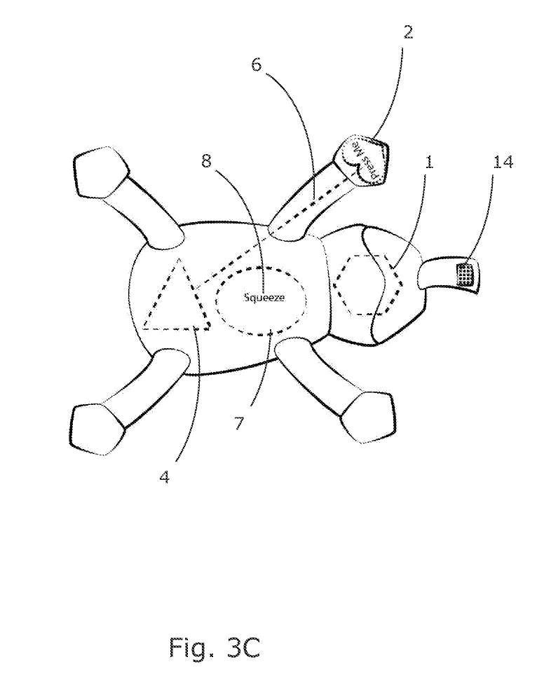

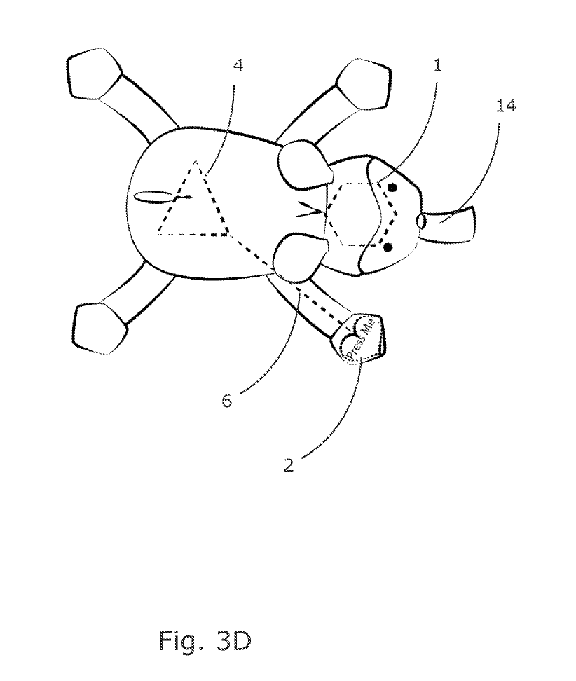

FIGS. 3A-3D illustrate an exemplified embodiment of the lamb. The rattle mechanism 1 is located with the lamb's head segment. The squeeze mechanism 7 is located in the top to mid-section of the body unit, and may further comprise a “Squeeze” designation 8 on the surface of the lamb's bottom side (i.e. stomach) in the form of a patch, imprinted, and/or stitched.

Furthermore, the right or left front hoof may comprise a stitching or imprint of “Press Me” designation 2 on the underside of the paw. Imprint 2 is connected via a connector wire 6 running up the hoof and leg and to a sound box 4 located near the rear of the body unit.

And as illustrated in FIG. 3D, there is an industrial grade Velcro-like strip that can be folded over to temporarily attach the pacifier handle to the underside of the lamb's tail.

### Monkey Toy

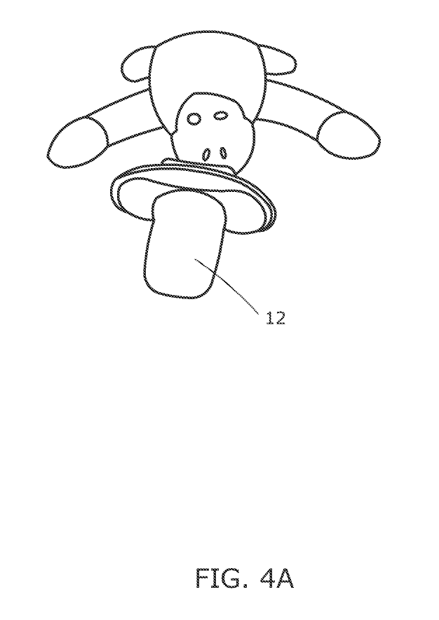

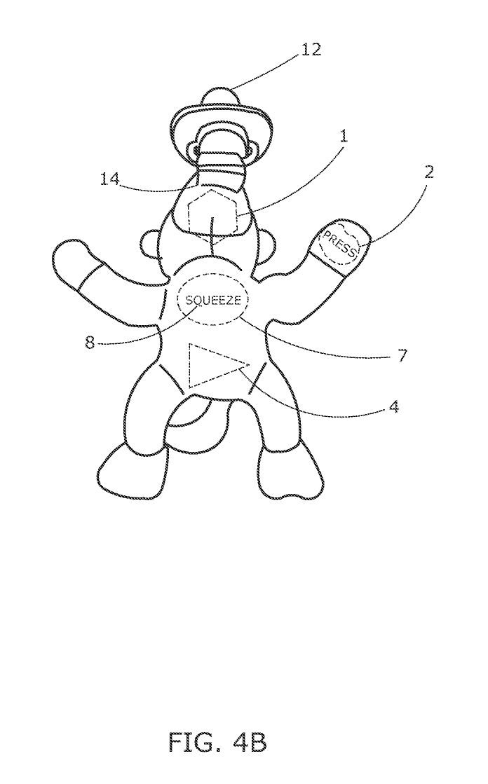

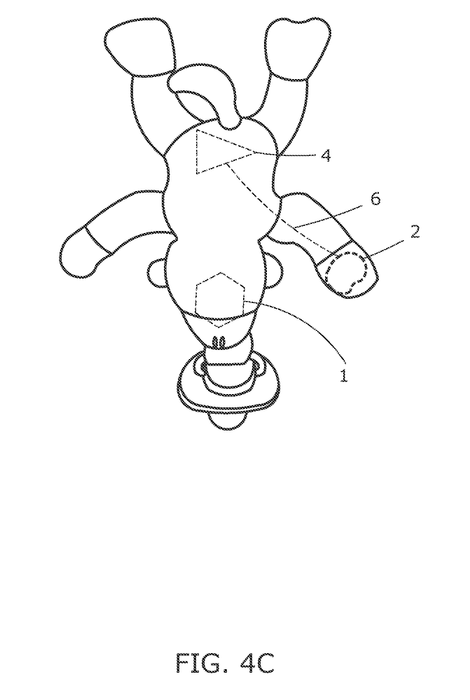

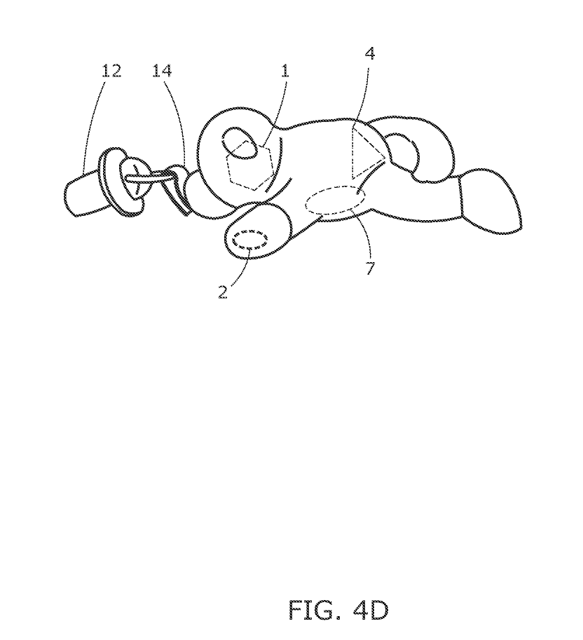

FIGS. 4A-4D illustrate an exemplified embodiment of the monkey. The rattle mechanism 1 is located within the monkey's head segment. The squeeze mechanism 7 is located in the top to mid-section of the body unit, and may further comprise a “Squeeze” designation 8 on the surface of the monkey (top, and/or side).

Furthermore, the right or left paw comprises a patch, stitching or imprint of “Press” or “Press Me” designation 2 on the underside of the paw. The exemplified heart shaped patch 2 is connected via a connector wire 6 running up the paw and to a sound box 3 located near the rear of the body unit by the tail.

And as illustrated in FIG. 4D, there is a Velcro-like strip that can be folded over to temporarily attach the pacifier handle to the underside or near the monkey's mouth.

### Puppy Toy

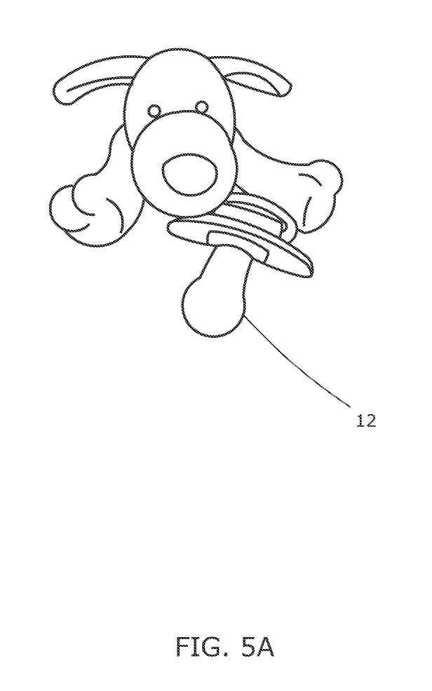

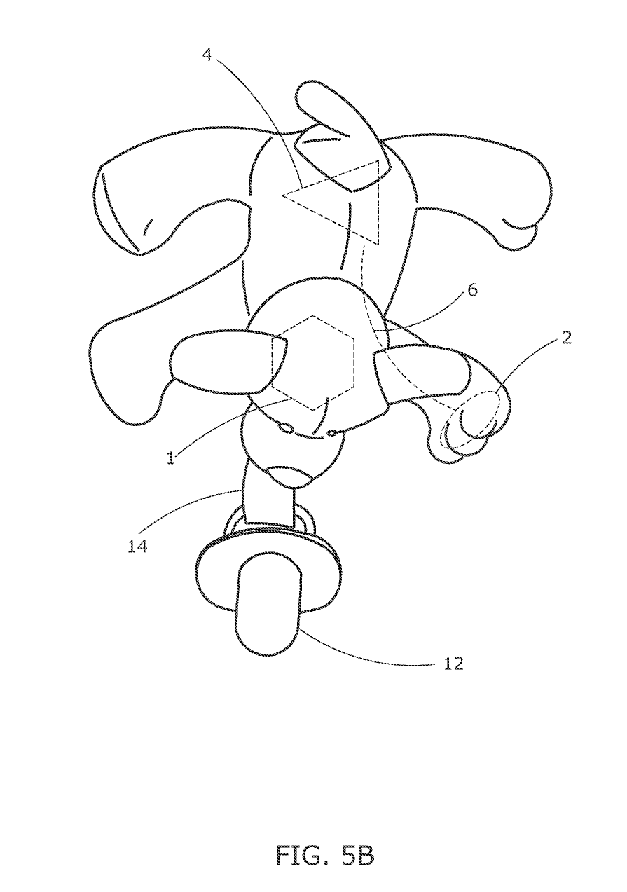

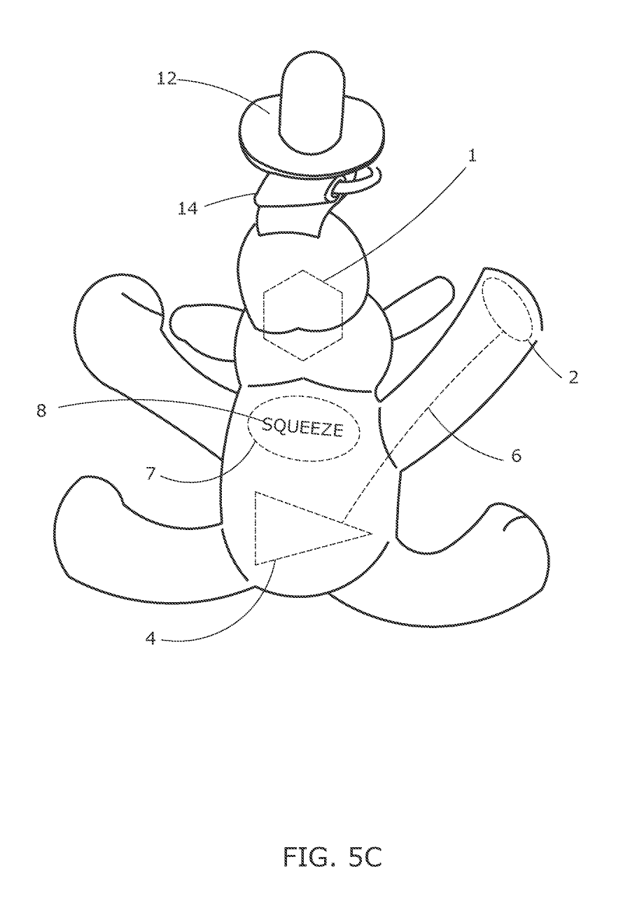

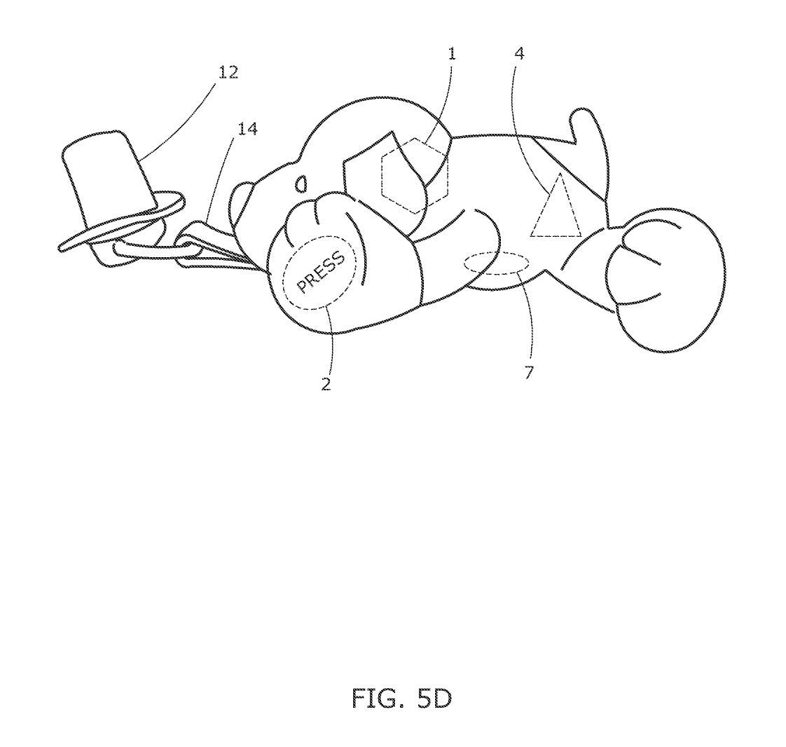

FIGS. 5A-5D illustrate an exemplified embodiment of the puppy. The rattle mechanism 1 is located within the puppy's head segment. The squeeze mechanism 7 is located in the top to mid-section of the body unit near the tail, and may or may not further comprise a “Squeeze” designation 8 on the stomach—bottom side—of the puppy.

Furthermore, and as illustrated in FIG. 5D, the right or left, front or back, paw comprises a patch, stitching or imprint of “Press Me” or “Press” designation 2 on the underside of the paw. The designation 2 is connected via a connector wire 6 running up the paw and to a sound box 4 located near the rear of the body unit by the tail

And as illustrated in FIG. 5D, there is a Velcro-like strip that can be folded over to attach the pacifier handle to the underside of, or near, the puppy's mouth.

It is additionally noted and anticipated that although the animal apparatus is shown in its most simple form, various components, features and aspects of the apparatus may be differently shaped or slightly modified when forming the disclosure herein. As such those skilled in the art will appreciate the descriptions and depictions set forth in this disclosure or merely meant to portray examples of preferred modes within the overall scope and intent of the disclosure, and are not to be considered limiting in any manner.

While all of the fundamental characteristics and features of the disclosure have been shown and described herein, with reference to particular embodiments thereof, a latitude of modification, various changes and substitutions are intended in the foregoing disclosure and it will be apparent that in some instances, some features of the disclosure may be employed without a corresponding use of other features without departing from the scope of the disclosure as set forth. It should also be understood that various substitutions, modifications, and variations may be made by those skilled in the art without departing from the spirit or scope of the disclosure or claims herein. Consequently, all such modifications and variations and substitutions are included within the scope of the disclosure as defined by the following claims.

What is claimed is:

1. An infant and toddler educational and amusement toy apparatus comprising:
a. a small-sized stuffed animal able to be held by an infant or toddler;
b. a rattle mechanism that emits a rattling noise when the toy is shaken; and
c. an auditory mechanism housed within the animal, wherein a pre-recorded song or voice is emitted when the toy is pressed at a designated press section.

2. The toy apparatus of claim 1, further comprising a temporary pacifier attachment device affixed to an external surface of the stuffed animal.

3. The toy apparatus of claim 2, wherein the attachment device is a flexible Velcro-like material configured to be inserted and removed from an opening of a pacifier handle, and affixed near the mouth of the stuffed animal.

4. The toy apparatus of claim 1, wherein the rattle mechanism is housed within a head segment of the stuffed animal.

5. The toy apparatus of claim 1, further comprising a squeeze mechanism able to emit a squeaky noise housed within the body of the stuffed animal.

6. The toy apparatus of claim 5, wherein the squeeze mechanism is activate-able by squeezing on a designated squeeze section on an external surface of the stuffed animal.

7. The toy apparatus of claim 1, wherein the pre-recorded song is the ABC song.

8. The toy apparatus of claim 1, further comprising one or more letters of the alphabet, numbers, or educational symbols displayed on an external surface of the stuffed animal.

9. The toy apparatus of claim 8, wherein the animal is a caterpillar.

10. The toy apparatus of claim 9, further comprising letters of the alphabet displayed on the external surface of the caterpillar.

11. The toy apparatus of claim 1, wherein the animal comprises one or more of: an elephant; a monkey; a lamb; and a puppy.

12. The toy apparatus of claim 10, wherein the animal further comprises a connector wire extending from the designated press section to the auditory mechanism to activate the pre-recording when the designated press section is pressed.

13. The toy apparatus of claim 11, wherein the designated press section is displayed on a bottom surface of an animal paw or hoof.

14. An infant educational and amusement toy apparatus comprising:
a. a small-sized stuffed animal able to be held by an infant or toddler;
b. an auditory mechanism housed within the animal, wherein a pre-recorded song or voice is emitted when the animal is pressed;
c. a rattle mechanism that emits a rattling noise when the animal is shaken; and,
d. a squeeze mechanism that emits a squeaky noise, wherein the squeeze mechanism is activated by squeezing on a designated squeeze section on an external surface of the animal.

15. The toy apparatus of claim 14, wherein the animal comprises one or more of: an elephant; a monkey; a lamb; and a puppy.

16. The toy apparatus of claim 14, further comprising a designated press section displayed on the external surface of the animal, and a connector wire extending from the designated press section to the auditory mechanism to activate the pre-recording when designated press section is pressed.

17. The toy apparatus of claim 16, wherein the designated press section is displayed on a bottom surface of an animal paw or hoof.

18. The toy apparatus of claim 17, wherein the rattle mechanism is housed within a head of the animal.

19. The toy apparatus of claim 14, wherein the pre-recorded song is the ABC song.

20. The toy apparatus of claim 14, wherein the animal is a caterpillar comprising a head segment and four or more body segments.

21. The toy apparatus of claim 20, further comprising a letter of the alphabet is displayed on a right and left side of each caterpillar body segment.

22. The toy apparatus of claim 14, further comprising a temporary pacifier attachment device affixed near a mouth of the stuffed animal comprising flexible Velcro-like material configured to be inserted and removed from an opening of a pacifier handle.
